(19) United States
(12) Patent Application Publication
(10) Pub. No.: US 2008/0022722 A1
(43) Pub. Date: Jan. 31, 2008

(54) METHODS FOR CONTINUOUSLY MANUFACTURING CRYSTALLIZED GLASS CURVED PANELS AND PIPES

(76) Inventor: Chi-Fu Tito Hsueh, Escondido, CA (US)

Correspondence Address: Chi-Fu Tito Hsueh, 2275 Montia Place, Escondido, CA, 92029, US

(21) Appl. No.: 11/306,308

(22) Filed: Dec. 22, 2005

(51) Int. Cl. C03B 27/012; C03B 23/02; C03B 23/057

(52) U.S. Cl. 65/33.1; 65/17.1; 65/36

(57) ABSTRACT

Methods for continuously manufacturing crystallized glass curved panels and pipes. The crystallized glass flat panel can be reformed by re-heating process. The method includes a reforming bed in the tunnel furnace that helps the flat panel to deform during transition. Three different reforming bed designs and processes are invented to produce convex and concave curved panels and pipes. In producing the pipe, both surfaces of the opening edges of the open pipe will be liquefied to liquid glass, even the pre-existing crystal structure. A roller squeezer will squeeze both edges together tightly, so they will be fusion bonded together. The closed pipe will be crystallized again so the crystals can grow between the bonding edges. The crystallized glass panel are made from crystallizable glass consist essentially of SiO₂—Al₂O₃—CaO or SiO₂—Al₂O₃—CaO—ZnO, or alike.

### BACKGROUND

1. Field of Inventions

This invention relates to the process of producing crystallized glass curved panels and pipes. The crystallized glass can be reformed by re-heating process. This invention can produce curved panel continuously with significant low cost. The crystallized glass curved panel can be used as ornamental building materials to replace the curved panel of natural stones that are considerably expensive. The crystallized glass has excellent characteristics in mechanical strength, heat-resistance, chemical corrosion strength, and water resistance. Therefore, the crystallized glass pipe will be ideal to replace the existing steel pipe, PVC pipe, and concrete pipe for sewage, water, and oil transmission and many other line pipe applications.

2. Discussion of Prior Art

Crystallized glass has been utilized in the manufacturing of such varied articles as cookware, tableware, missile nose cones, protective shields, and in the computer and electronics field. Nowadays, crystallized glass has been used as ornamental building materials to replace the natural stones due to its excellent characteristics in mechanical strength, heat-resistance, chemical corrosion strength, and water resistance, and has obtained great popularity. Several patents regarding crystallized glass (G.B. 1427792, 1972; U.S. Pat. No. 5,403,664, Kurahashi et al., Apr. 4, 1995; U.S. Pat. No. 5,885,315, Fredholm et al., Mar, 23, 1999) disclose the methods of producing flat panel, (U.S. Pat. No. 3,955,989, Nakamura, May 11, 1976; U.S. Pat. No. 4,054,435, Sakane et al., May 11, 1976; U.S. Pat. No. 2,339,975, Henry, Jan. 25, 1944) changing the color pattern of the surface, or (U.S. Pat. No. 3,843,343, Okada et al., Apr. 12, 1973; U.S. Pat. No. 5,089,345, Hashibe et al., Feb. 18, 1992) making irregular rough surface pattern on the flat panel. No patents disclose any method of producing crystallized glass curved panels and pipes.

Currently, the crystallized glass curved panel is produced by first placing a flat panel on a mold with desired curvature. It is then heated inside the furnace. When the crystallized glass flat panel heats up over the softening point, the panel begins to soften down to the curved mold and forms a curved panel. This process requires the gravity to bring the flat panel down to the curved mold. One problem is that the center part of the flat panel usually drops down first and at rapid speed; it often tears off the panel itself. To resolve the problem would require setting the flat panel up at a 30-60 degree angle in the mold rather than at the horizontal position. This reduces the weight at the center to a fraction of sine function. However, this method usually limits the size of the curved panel to less than ⅓ of a circle, and it cannot be adopted in mass production process.

Steel pipes are produced mainly by electric resistance welding with high frequency current or by irradiation with a laser beam. These processes (U.S. Pat. No. 4,449,386, Akita et al., Mar. 22, 1984; U.S. Pat. No. 5,000,369, Shotts, et al., Mar. 19, 1991; U.S. Pat. No. 5,054,679, Shotts, et al., Oct. 8, 1991; U.S. Pat. No. 5,942,132, Toyooka et al., Aug. 24, 1999) for their production consists of continuously feeding a flat strip steel, making it into a pipe stock using a forming roll, heating the opposing edges of the pipe stock to a temperature above the melting point of steel by means of high frequency current or by irradiation with a laser beam, and butt-welding the heated edges by means of squeeze rolls. Steel products for line pipe need resistance to stress corrosion cracking by sulfides, and this object is achieved by hardness control through the reduction of impurities or the adjustment of alloying elements. The disadvantage of these methods is the complexity of processes and high production cost.

PVC pipe has been widely used in various applications. However, due to its low resistance to chemical actions and weakness in strength, it cannot be used under heavy-duty environments.

### OBJECTS AND ADVANTAGES

Crystallized glass can easily be reformed into desired curvature with re-heating process. It is considered much less efforts and costs in comparison to the production of curved products of natural stone. The present invention can produce crystallized glass curved panel over ½ circles that is not possible to produce now.

Crystallized glass has high chemical resistance to corrosion and great mechanical strength against damages. The present invention can also produce crystallized glass pipe to replace the existing steal pipe, PVC pipe, and concrete pipe for sewage, water, and oil transmission and many other line pipe applications.

### SUMMARY OF THE INVENTION

The present invention of producing curved panel with concave curvature consists of a reforming bed inside the tunnel furnace. The reforming bed starts flat then changes its curvature linearly, slowly to its target curvature. The FIG. 1 illustrates a reforming bed with a convex curvature to produce curved panel with concave curvature. The procedure follows as:

A flat panel is prepared according to the specification of the curved panel in size and thickness. The panel is placed on the reforming bed with acquired surface face down. It gradually moves forward on the bed in the furnace by an external pushing pole. The tunnel furnace has a designed temperature profile according to the type of crystallized glass material. The pre-heating process heats up the flat panel at the temperature lower than its softening temperature. The flat panel will remain flat at this stage. When the temperature of furnace rises above the softening temperature of crystallized glass but remains lower than its crystallizing temperature, the flat panel softens and the reforming bed begins to change its curvature slowly until it reaches its target curvature. As the flat panel moves forward, it reforms along with the reforming bed. The length of this transition varies upon the temperature profile. The higher the temperature we use, the shorter the reforming time we need, and therefore the shorter the reforming bed we need. The pushing speed is determined by the reforming time it takes.

In order to have the curved panel fully attached to the reforming bed, a mechanical roller or presser is often used to laminate over the curved panel. One alternative without using any mechanical tooling is to quickly raise the temperature higher than its crystallizing temperature but lower than its liquefied temperature of crystallized glass material, and then set for a short period. This process is referred to as shocking. It allows the glass structure in the panel to be much softened, but disallows the crystal structure enough time to grow. When the curvature of the bed reaches the target curvature, the shocking is applied so the curved panel completely softens down on the reforming bed, attaching to its curved surface, and becoming a perfect curved panel.

In completion of reformation process, the curved panel will be air cooled in the furnace and gradually pushed out. Since the reformation requires the force of gravity, the reforming bed is usually convex. Since the panel is placed with acquired surface face down on the bed, the finishing curved panel will have a concaved curvature as targeted.

To produce a curved crystallized glass panel with convex curvature, we will need to place the flat panel on the reforming bed with acquired surface face up. The reforming bed is designed into two sections. The first section consists of a reforming bed with a convex curvature as above. The radius of the curvature of the bed will be the radius of the target curvature minus the thickness of the panel. The flat panel will be pre-heated and reformed as above. The second section consists of a bed with a concave curvature as the target curvature. A mechanical mechanism moves the deformed panel from the convex bed in section 1 to the concave bed in section 2. An additional pushing pole of the section 2 is used to push the curved panel forward. The shocking is applied at the beginning of section 2, so the curved panel completely softens down on the concave bed, attaching to its curved surface, and becoming a perfect curved panel. It will then be air cooled in the furnace and gradually pushed out. When the deformed panel moves from the convex bed in section 1 to the concave bed in section 2, the acquired surface of the curved panel becomes face down on the concave bed, so the finishing curved panel will have a convex curvature as targeted. The FIG. 2 illustrates the reforming bed to produce curved panel with convex curvature.

To produce a crystallized glass pipe, the reforming bed is designed into two sections. The first section consists of a reforming bed with convex curvature that changes curvature from flat to half circle with radius of the pipe. The flat panel has thickness as the specified pipe; the width at the bottom surface equals to the inner diameter of specified pipe, and the width at the top surface equals to the outer diameter of the specified pipe. This flat panel is placed on the reforming bed with acquired surface face down. The flat panel will then be pre-heated and reformed into an up-side-down half-circle U shape. The second section is a cylinder post with radius of the pipe. It also consists of a roller squeezer and a linear heating element.

In completion of the reformation process in section 1, the curved glass article is pushed onto the cylinder post. The shocking is then applied. The roller squeezer will then roll over the curved glass article, so the article will be completely attached to the post with 3-5 mm opening at the opening end. A linear heating element is set between the openings at temperature over liquefied temperature. This will liquefy both surfaces of the opening edges to liquid glass, even the pre-existing crystal structure. The roller squeezer will then squeeze together tightly, so both edges will be fusion bonded together. In completion of this process, the crystallized glass pipe will be under crystallization process again so the crystals can grow between the bonding edges. It will then be air cooled in the furnace and gradually pushed out. The FIG. 3 illustrates the reforming bed to produce the closed pipe.

### BRIEF DESCRIPTION OF THE DRAWINGS

FIG. 1 illustrates a reforming bed with convex curvature to produce curved panel with concave curvature.

FIG. 2 illustrates a reforming bed with both convex and concave curvature to produce curved panel with convex curvature.

FIG. 3 illustrates a reforming bed with convex curvature and a circular post to produce the closed pipe.

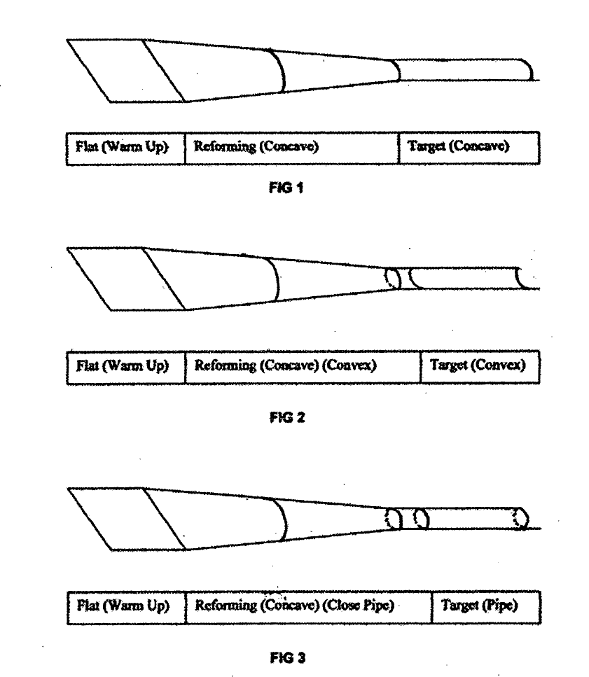

What is claimed is:

1. A method of continuously producing crystallized glass curved panel with concave curvature comprising the steps of: Loading; Pre-heating, Reforming, and Shocking.

2. The crystallized glass flat panel claimed in claim 1, wherein said made from crystallizable glass consist essentially of SiO₂, Al₂O₃, and CaO.

3. The crystallized glass flat panel claimed in claim 1, wherein said made from crystallizable glass consist essentially of SiO₂, Al₂O₃, CaO, and ZnO.

4. The loading process claimed in claim 1, wherein said is to place the pre-sized flat panel on the reforming bed with acquired surface face down.

5. The pre-heating process claimed in claim 1, wherein said is to heat the flat panel under temperature below its softening temperature of the type of crystallized glass.

6. The reforming process claimed in claim 1, wherein said is to heat the panel under temperature above its softening temperature and below its crystallizing temperature of the type of crystallized glass, so the flat panel is softening down on the reforming bed.

7. The shocking process claimed in claim 1, wherein said is to raise the temperature quickly above its crystallizing temperature and below its liquefied temperature of the type of crystallized glass and stay for a short period, so the deformed flat panel is completely softened down on the reforming bed.

8. The reforming bed as set forth in claim 1, wherein said comprises the carrying bed in the furnace that changes its curvature from flat to its target curvature convexly and slowly.

9. A method of continuously producing crystallized glass curved panel with convex curvature comprising the steps of: Loading, Pre-heating, Reforming, Transporting, and Shocking.

10. The crystallized glass flat panel claimed in claim 9, wherein said made from crystallizable glass consist essentially of SiO₂, A1₂O₃, and CaO.

11. The crystallized glass flat panel claimed in claim 9, wherein said made from crystallizable glass consist essentially of SiO₂, Al₂O₃, CaO, and ZnO.

12. The loading process claimed in claim 9, wherein said is to place the flat panel on the reforming bed with acquired surface face up.

13. The pre-heating process claimed in claim 9, wherein said is to heat the flat panel under temperature below its softening temperature of the type of crystallized glass.

14. The reforming process claimed in claim 9, wherein said is to heat the flat panel under temperature above its softening temperature and below its crystallizing temperature of the type of crystallized glass, so the flat panel softens down on the reforming bed.

15. The transporting process claimed in claim 9, wherein said is to move the deformed flat panel from the convex bed to the concave bed by a moving mechanism.

16. The shocking process claimed in claim 9, wherein said is to raise the temperature quickly above its crystallizing temperature and below its liquefied temperature of crystallized glass material and stay for a short period, so the deformed flat panel is completely softened down on the reforming bed.

17. The reforming bed as set forth in claim 9, wherein said comprises: a carrying bed (convex bed) that changes its curvature from flat to a curved curvature convexly and slowly where the radius of the curved curvature is less than the radius of the target curvature minus the thickness of the flat panel; a carrying bed (concave bed) with target curvature; a mechanical mechanism that transports the deformed panel from the convex bed to the concave bed; an either mechanical or hydraulic driven pushing pole that pushes the curved panel forward in the concave bed.

18. A method of continuously producing close pipe comprising the steps of: Pre-sizing, Loading, Pre-heating, Reforming, Shocking, Roll-Over, Liquefying, Squeezing, and Crystallizing.

19. The crystallized glass flat panel claimed in claim 18, wherein said made from crystallizable glass consist essentially of SiO₂, Al₂O₃, and CaO.

20. The crystallized glass flat panel claimed in claim 18, wherein said made from crystallizable glass consist essentially of SiO₂, Al₂O₃, CaO, and ZnO.

21. The pre-sizing process claimed in claim 18, wherein said to have the width at the bottom of the flat panel equals to the inner diameter of specified pipe multiple π, and the width at the top equals to the outer diameter of the specified pipe multiple π.

22. The loading process claimed in claim 18, wherein said is placed on the reforming bed with acquired surface face down.

23. The pre-heating process claimed in claim 18, wherein said is to heat the flat panel under temperature below its softening temperature of the type of crystallized glass.

24. The pushing flat panel claimed in claim 18, wherein said is to push the flat panel from the entrance of the furnace by a mechanical or hydraulic driven pole forward on the reforming bed.

25. The reforming process claimed in claim 18, wherein said is to heat the flat panel under temperature above its softening temperature and below its crystallizing temperature of the type of crystallized glass, so the flat panel is softening down on the reforming bed.

26. The shocking process claimed in claim 18, wherein said is to raise the temperature quickly above its crystallizing temperature and below its liquefied temperature of crystallized glass material and stay for a short period, so the deformed flat panel is completely softened down on the cylinder post.

27. The roll-over process claimed in claim 18, wherein said is to have a mechanical roller that rolls over the deformed panel on the cylinder post from both sides, top to bottom, to form a 3-5 mm open pipe.

28. The liquefying process claimed in claim 18, wherein said is to heat both surfaces of the openings of the open pipe at temperature over liquefied temperature, so both the glass structure and crystal structure become liquid glass.

29. The squeezing process claimed in claim 18, wherein said is to have a squeezer that squeezes the two opposing open edges against each other, so both edges will be fusion bonded together to form a closed pipe.

30. The crystallizing process claimed in claim 18, where said is to heat the reformed closed pipe under crystallization temperature, so the crystals can grow between the bonding edges.

31. The reforming bed as set forth in claim 18, wherein said comprises: a carrying bed (convex bed) that changes its curvature from flat to half circle with radius of the pipe; a cylinder post with outer dimension equals to the inner dimension of the pipe; a roller squeezer; and a linear heating element.
